(19) United States
(12) Patent Application Publication
(10) Pub. No.: US 2020/0082474 A1
(43) Pub. Date: Mar. 12, 2020

(54) MANAGEMENT INFORMATION SYSTEM, METHOD, AND PROGRAM

(71) Applicant: SUMITOMO MITSUI BANKING CORPORATION, Tokyo (JP)

(72) Inventor: Kiyonori UGAJIN, Tokyo (JP)

(21) Appl. No.: 16/494,147

(22) PCT Filed: Mar. 17, 2017
(86) PCT No.: PCT/JP2017/011058

§ 371 Date: Sep. 13, 2019

(51) Int. Cl. G06Q 40/00; G06Q 40/02; G06Q 40/08

(52) U.S. Cl. CPC G06Q 40/12; G06Q 40/08; G06Q 40/02

(57) ABSTRACT

A management information system includes: a database compilation unit configured to receive base data managed by the business systems based on respective standards, from the business systems, the base data including data of multiple items and being managed on a record basis; an extraction unit configured to extract data of one or more items out of the received base data; a common code assigning unit configured to generate standardized data manageable based on a unified standard by assigning a common code to the extracted data of the one or more items; and a basic figure generation unit configured to generate a basic figure by combining multiple pieces of the standardized data based on the common code, the basic figure being used for the management of the financial institution or the financial holding company group including the financial institution.

### TECHNICAL FIELD

The present invention relates to a technique for providing information that is referred to for a managerial judgment or decision making of a financial institution or a financial holding company group. More particularly, the present invention relates to a technique to manage data used for the management accounting and financial accounting of a financial institution or a financial holding company group.

### BACKGROUND ART

Accounting information on management accounting, a kind of corporate accounting, is referred to in order to make a managerial judgment or decision of a financial institution or a financial holding company group. In management accounting, various kinds of information inside the company are collected and analyzed according to the purpose to provide numerical values for enabling grasping of the managerial situation and issues.

For example, for management accounting of a financial institution or a financial holding company group, it is necessary to grasp the actual situations of operations such as deposits, lending, and currency exchange at domestic and foreign locations. In addition, it is necessary to grasp not only the management situation within the company but also those of group companies under the same financial holding company. Thus, the management accounting of a financial institution or a financial holding company group is required to use a wide variety of information scattered widely across the company and the group companies.

In addition, the management accounting of a financial institution or a financial holding company group needs to handle matters such as credit risk, market risk, liquidity risk, and domestic and foreign financial regulations that cannot be handled in conventional financial accounting frameworks. Operations in the financial institution involve various risks. Nowadays, it is required to quantify these risks and include them in the accounting information of management accounting.

Conventionally, a staff member in a financial institution collects data scattered across databases in all business systems inside the company and analyses the data on a personal computer at hand to generate accounting information of management accounting. Specifically, a staff member combines partial information pieces scattered across multiple databases—part of data in a database in the company, part of data in another database, part of data in still another database, and so on—to generate accounting information of management accounting.

### SUMMARY OF INVENTION

### Technical Problem

Unfortunately, a financial institution and its group companies have a large number of business systems including an accounting system, and each business system has an immense number of databases. In addition, these databases are not formed consistently among the departments and group companies, in other words, among the business systems. Each of the departments and group companies defines items in a database independently and calculates numerical values of those items on its own grounds. In other words, data inside a company is not managed based on common definitions and common calculation grounds across all the departments and all the group companies. Thus, it has been difficult to manage data in those databases as accounting information of management accounting based on a consistent system and provide the data for the managers in a timely and appropriate manner.

In particular, financial information and risk information have conventionally been managed separately and thus have not necessarily been managed on the same basis. Thus, it has been difficult to provide information on risks involved in operations of a financial institution for the managers in a timely and appropriate manner.

The present invention has been made in light of the above problems, and an object thereof is to provide a system, method, and program that enables data in databases managed by multiple business systems in a financial institution or a financial holding company to be used effectively in order to provide information for the managers of the company in a timely and appropriate manner.

### Solution to Problem

To achieve the objective, an aspect of the present invention is a management information system connected to multiple business systems inside and outside a company, located in a home country and a foreign country, and the management information system is a system to support management of a financial institution or a financial holding company group including the financial institution. The management information system includes: a database compilation unit configured to receive base data managed by the business systems based on respective standards, from the business systems, the base data including data of multiple items and being managed on a record basis; an extraction unit configured to extract data of one or more items out of the received base data; a common code assigning unit configured to generate standardized data manageable based on a unified standard by assigning a common code to the extracted data of the one or more items; and a basic figure generation unit configured to generate a basic figure by combining multiple pieces of the standardized data based on the common code, the basic figure being used for the management of the financial institution or the financial holding company group including the financial institution.

### Advantageous Effects of Invention

The present invention enables data within a financial institution or group companies under a financial holding company group to be used effectively for the management of the financial institution or the financial holding company group by extracting data of some items in databases managed by multiple business systems in the company or in the group companies under the financial holding company and assigning common codes to this extracted data so that the outer forms of risk information and financial information match and thus the risk information and the financial information can be handled within the same framework.

### BRIEF DESCRIPTION OF DRAWINGS

FIG. 1 is an overall schematic diagram including a management information system according to an embodiment of the present invention;

FIG. 2 is a functional block diagram of the management information system according to the embodiment of the present invention;

FIG. 3 is a data transition diagram of the management information system according to the embodiment of the present invention;

FIG. 4 is an example of data of the management information system according to the embodiment of the present invention;

FIG. 5 is an example of a standardized data definition database of the management information system according to the embodiment of the present invention;

FIG. 6 is an example of a common code database of the management information system according to the embodiment of the present invention; and

FIG. 7 is a sequence diagram illustrating a process procedure of the management information system according to the embodiment of the present invention.

### DESCRIPTION OF EMBODIMENTS

Hereinafter, an embodiment of the present invention will be described in detail with reference to the drawings. In this specification, the present invention will be described mainly in terms of management accounting, but the present invention can be utilized to generate accounting information on management accounting and financial accounting. The present invention can be used to generate accounting information on the management accounting and financial accounting of a financial institution, the management accounting and financial accounting of a whole financial holding company group, and the management accounting and financial accounting of group companies under a financial holding company.

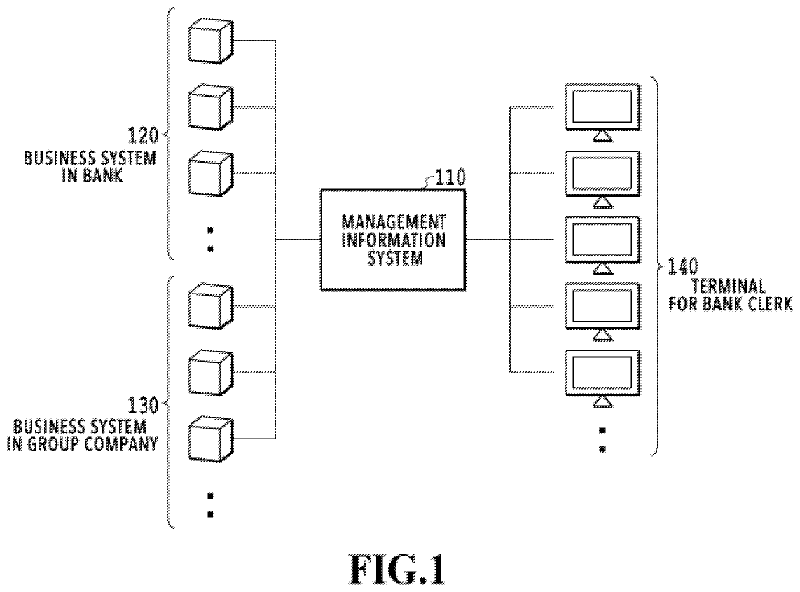

With reference to FIG. 1, first an overall configuration including a management information system 110 according to an embodiment of the present invention is explained. The management information system 110 is a system for compiling and managing information in databases held by multiple business systems 120 and 130, for the management accounting and financial accounting of a bank or a financial holding company group. The business systems 120 in the bank are business systems such as an accounting systems in the bank. The business systems 130 in the group companies are business systems in group companies (such as a securities company) of the bank. Terminals 140 for bank clerks are terminals for bank clerks to use the management information system 110. Hereinafter, each system and terminal will be described in detail.

Note that the business systems 120 and 130 are systems located in the home country and foreign countries and may include systems for financial operations of the bank and the group companies and systems for any operations other than finance (for example, risk management and the like). Thus, the management information system 110 is capable of compiling not only data on financial operations but also data that has not been used for conventional financial accounting including data on risks such as credit risk, and making use of them for the management accounting and financial accounting.

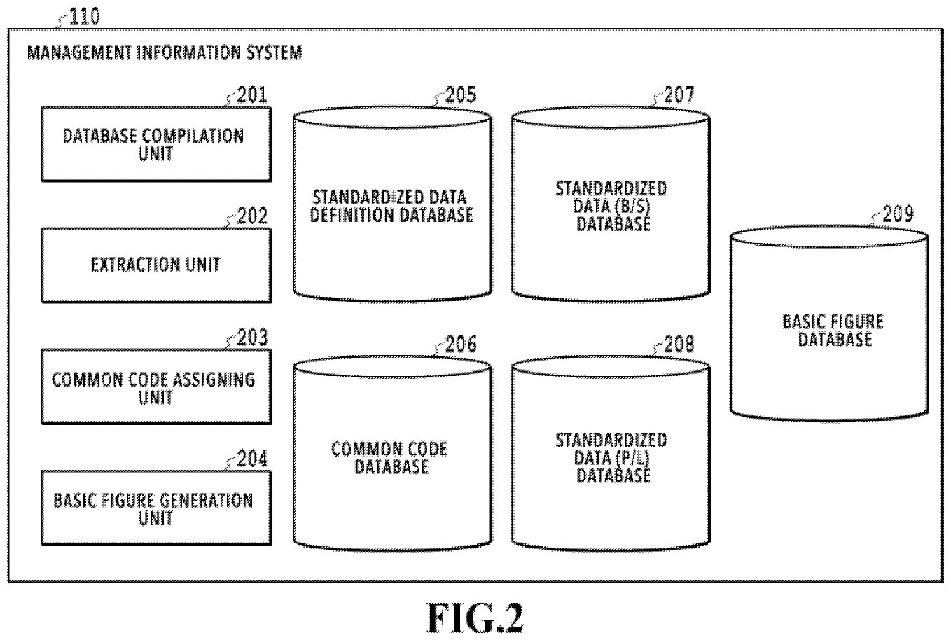

The management information system 110 is a system for supporting the management of a financial institution or a financial holding company group including a financial institution. The management information system 110 extracts data of some items in databases held by the business systems 120 in a bank and the business systems 130 in group companies and assigns common codes to this extracted data, so that data in the business systems 120 and 130 can be made use of for the management accounting and financial accounting of the bank or the financial holding company group. Hereinafter, the management information system 110 will be described in detail with reference to FIG. 2.

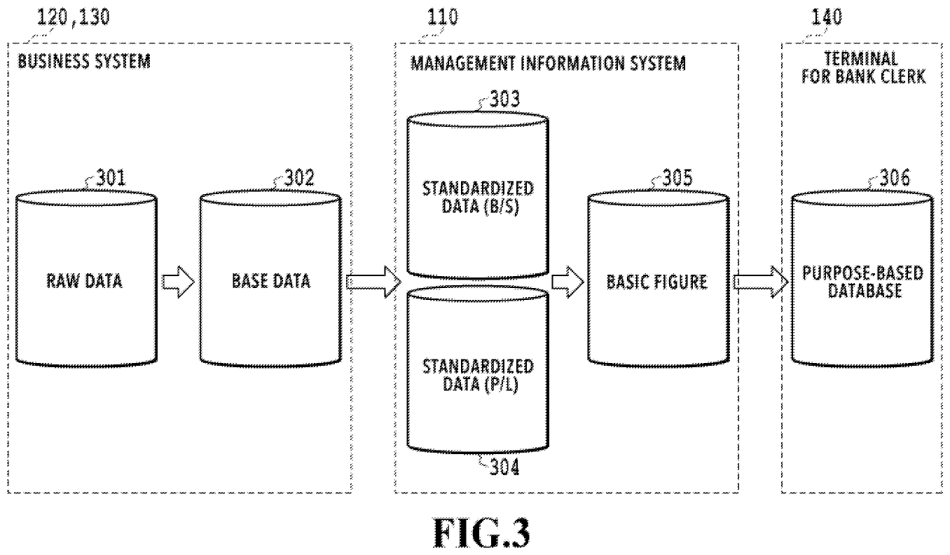

FIG. 2 is a functional block diagram of the management information system 110 according to an embodiment of the present invention. The management information system 110 may include a database compilation unit 201, extraction unit 202, common code assigning unit 203, basic figure generation unit 204, standardized data definition database 205, common code database 206, standardized data (B/S) database 207, standardized data (P/L) database 208, and basic figure database 209. The management information system 110 is a computer including a processor and memory. The management information system 110 also includes a storage medium storing a program for causing the database compilation unit 201, extraction unit 202, common code assigning unit 203, and basic figure generation unit 204 to operate, or a program for executing process procedures described later. The management information system 110 can transmit and receive data to and from each of the business systems 120 in the bank, the business systems 130 in the group companies, and the terminals 140 for bank clerks. Before each of the database compilation unit 201 to the basic figure database 209 is described in detail, data transition in the present invention will be described below in detail with reference to FIG. 3.

FIG. 3 is a data transition diagram for the management information system according to the embodiment of the present invention.

### <Raw Data>

First, raw data 301 in the business systems 120 and 130 will be described. The raw data 301 is raw data stored in the business systems 120 and 130. The raw data 301 includes, for example, data such as deposit and withdrawal details of accounts, fees, credit details, collateral/guarantee details, rating information, market-based revenue, and expenses.

### <Base Data>

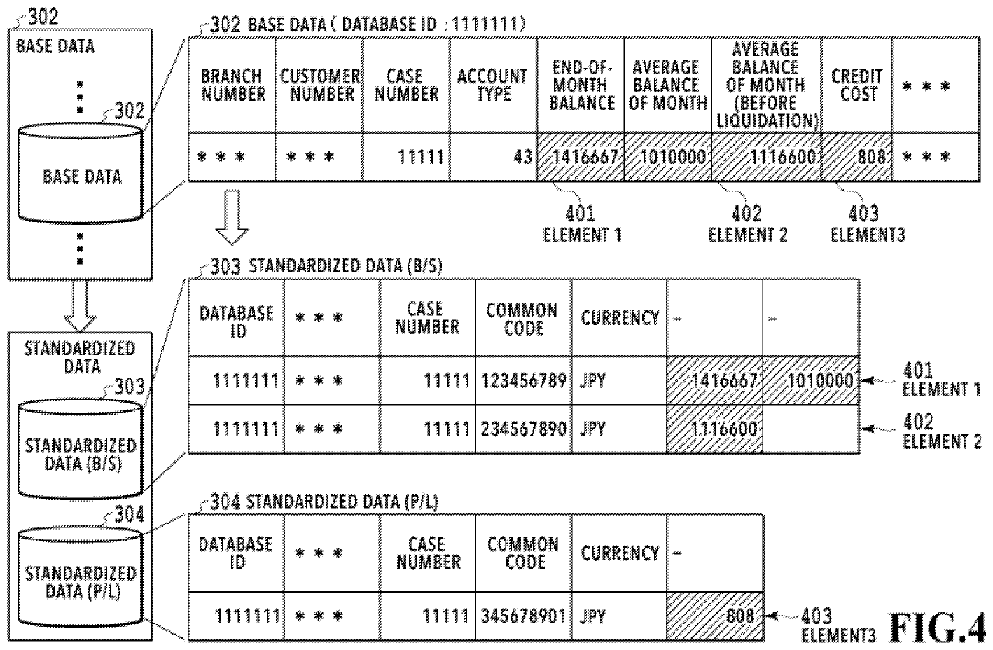

Next, base data 302 in the business systems 120 and 130 will be described. The base data 302 can be generated based on the raw data 301. Each of the business systems 120 and 130 can build databases for its operation based on the raw data 301 (this database is called base data 302). The base data 302 includes data of one or more items. As described later, data of some items is extracted out of the base data 302 to be used for standardized data 303 or 304. The base data 302 is, for example, a database on domestic or foreign deposit operation, a database on domestic or foreign lending operation, and the like. A specific example of the base data 302 will be described with reference to FIG. 4.

### <Standardized Data>

Next, the standardized data 303 and 304 in the management information system 110 will be described. The standardized data 303 and 304 can be generated based on the base data 302. The management information system 110 can extract data of some selected items in the base data 302. The number of the selected items may be one or more (hereinafter, these “selected items” are also referred to as the “elements”). In addition, the management information system 110 can generate the standardized data 303 or 304 by assigning common codes to this extracted data (in other words, by assigning a common code to data of each element). The standardized data can be classified into the standardized data 303 on B/S (balance sheet) and the standardized data 304 on P/L (profit-and-loss statement). As described later, multiple pieces of standardized data 303 and 304 are combined to be used as basic figures 305. A specific example of the standardized data 303 and 304 will be described with reference to FIG. 4.

### <Basic Figure>

Next, the basic figures 305 in the management information system 110 will be described. The basic figures 305 can be generated based on the standardized data 303 and 304. The management information system 110 can generate the basic figures 305 by combining multiple pieces of standardized data 303 and 304 based on common codes. The basic figures 305 include, for example, a database in which pieces of standardized data 303 and 304 are combined for each customer, a database in which pieces of standardized data 303 and 304 are combined for each transaction (deal), and the like. The basic figures are used for the management of a financial institution or a financial holding company group including a financial institution. As described later, a purpose-based database 306 are built based on the basic figures 305.

### <Purpose-Based Database>

Lastly, the purpose-based database 306 in the terminal 140 for bank clerks will be described. The purpose-based database 306 can be built based on the basic figures 305. The terminal 140 for bank clerks can build the database 306 for a specific purpose using the basic figures 305. In addition, the terminal 140 for bank clerks can store the built purpose-based database 306 in the management information system 110. The purpose-based database 306 is accounting information including numerical values into which risks such as credit risk are quantified. Specifically, the accounting information on management accounting or financial accounting generated using the present invention is accounting information calculated from risk information and financial information the outer forms of which are unified.

FIG. 4 is an example of data of the management information system 110 according to the embodiment of the present invention. In the example of FIG. 4, the base data 302 is on the operation of lending (financing). For example, the base data 302 includes data of items such as “end-of-month balance”, “average balance of the month”, “average balance of the month (before liquidation)”, and “credit costs”. Note that here the “end-of-month balance” and “average balance of the month” will be referred to as element 1 401, the “average balance of the month (before liquidation)” as element 2 402, and the “credit costs” as element 3 403. In the base data 302 in FIG. 4, data is managed on a lending-case basis (in other words, on a financing-transaction basis or a deal basis). Thus, the base data 302 is managed by the record, for example, on a case basis, on a contract basis, on a deal basis, on an account basis, and on a customer basis, depending on the operation of each department.

The lower right part of FIG. 4 shows the standardized data 303 and 304. Specifically, data of the element 1 401 of the base data 302 (specifically, the “end-of-month balance” and “average balance of the month”) is extracted and stored in the standardized data (B/S) 303 (in the upper part). Then the common code “123456789” is assigned to this data of element 1 401. In addition, data of element 2 402 in the base data 302 (specifically, the “average balance of the month (before liquidation)”) is extracted and stored in the standardized data (B/S) 303 (in the lower part). Then the common code “234567890” is assigned to this data of element 2 402. In the standardized data (P/L) 304, data of element 3 403 in the base data 302 (specifically, “credit costs”) is extracted and stored. Then the common code “345678901” is assigned to this data of element 3 403. Thus, one piece of base data 302 that is managed with the case number “11111” is divided into three pieces of standardized data 303 and 304. In other words, a piece of base data 302 that is managed as one record is divided into multiple pieces of standardized data 303 and 304, and a common code is assigned to each piece.

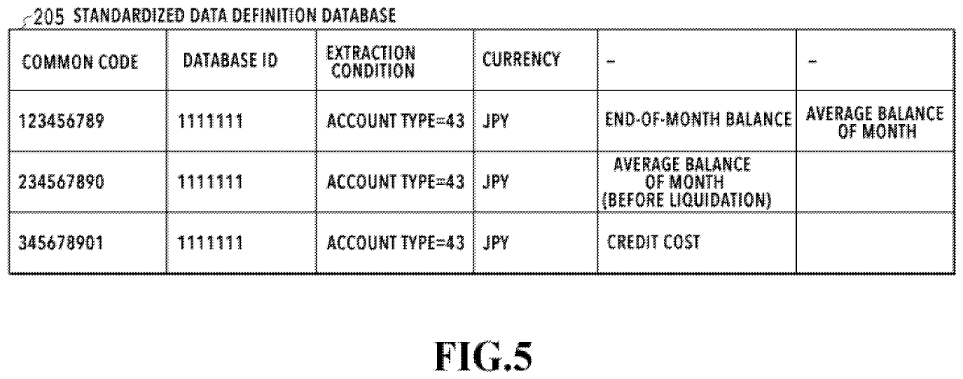

As will be described below with reference to FIG. 5, the management information system 110 can determine the data of which items is to be extracted as the standardized data 303 and 304 out of the multiple items in the base data 302 based on the standardized data definition database 205. In addition, the management information system 110 can assign common codes to the extracted data based on the standardized data definition database 205.

FIG. 5 is an example of a standardized data definition database 205 of the management information system according to the embodiment of the present invention. As described above, the standardized data definition database 205 is a database for specifying the items the data of which is to be extracted as the standardized data 303 and 304 out of the multiple items in the base data 302. The standardized data definition database 205 can define any extraction conditions such as the identifiers of databases (indicating which database) in the business systems 120 and 130 and item names (indicating which items). As described above, the standardized data definition database 205 is a database also for specifying common codes to be assigned to extracted data. The standardized data definition database 205 can define common codes for data of one or more items to be extracted (in other words, data of each element).

As above, the base data 302 in databases of the business systems 120 and 130 is managed as the standardized data 303 and 304 so that it can be easily used for the management accounting and financial accounting. In other words, data managed on a record basis including multiple elements adapted to operations (in other words, the base data 302) is componentized into data on an element basis (in other words, the standardized data 303 and 304). Thus, data is extracted on an element basis from databases (in other words, base data 302) built by each department or group company based on its own standard, and the extracted data can be set as the data managed based on a standard unified as a whole using the common codes (in other words, standardized data 303 and 304).

Returning to FIG. 2, each of the database compilation unit 201 to the basic figure database 209 will be described in detail below.

The database compilation unit 201 can receive base data 302 from the business systems 120 in the bank and the business systems 130 in the group companies. The database compilation unit 201 can store the received base data 302 in memory (not illustrated).

The extraction unit 202 can extract data of some items in the base data 302 received by the database compilation unit 201 based on the standardized data definition database 205. The extraction unit 202 can store the extracted data in memory (not illustrated).

The common code assigning unit 203 can assign common codes to the data extracted by the extraction unit 202, based on the standardized data definition database 205. Specifically, the common code assigning unit 203 can associate the data extracted by the extraction unit 202 with the common codes defined for the extracted data in the standardized data definition database 205 and can store the associated data and common codes in the standardized data (B/S) database 207 or the standardized data (P/L) database 208. Whether data is to be stored in the standardized data (B/S) database 207 or the standardized data (P/L) database 208 is determined based on its common code.

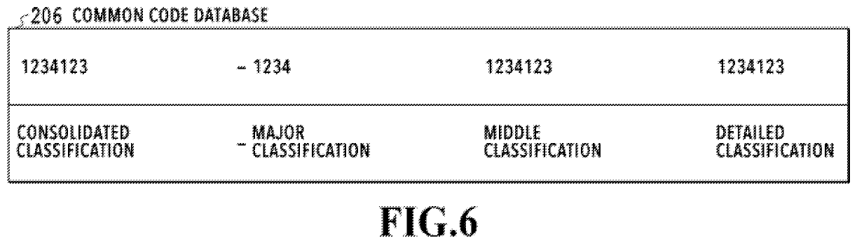

The basic figure generation unit 204 can generate basic figures 305 by combining multiple pieces of standardized data 303 and 304 in the standardized data (B/S) database 207 and the standardized data (P/L) database 208. Specifically, the basic figure generation unit 204 can combine multiple pieces of standardized data 303 and 304 based on the common codes assigned to the standardized data 303 and 304. For example, the basic figure generation unit 204 can perform calculation using the standardized data 303 and 304 for each code of each classification of the common codes (see FIG. 6) on a customer basis (or on a department basis or the like). Specifically, for a certain customer, a calculation is performed using figures having, for example, the major classification code “1234” in the standardized data 303 and 304. As above, data including multiple data pieces of standardized data 303 and 304 (in other words, the basic figures 305), adapted for each operation is generated based on the common codes of the standardized data 303 and 304.

The standardized data definition database 205 is, as has been described with reference to FIG. 5, a database for storing information on the items of the data of which is to be extracted as the standardized data 303 and 304 and the common codes to be assigned to the extracted data. Based on the standardized data definition database 205, the standardized data 303 and 304 is generated from the base data 302.

The common code database 206 is a database that stores the definition of each common code. The same common codes are codes shared throughout the bank and the group companies. The common codes enable the content of the data of the standardized data 303 and 304 to be identified. As illustrated in FIG. 6, the common codes have multiple classifications. The common code of a data piece of standardized data specifies whether the data piece is to be classified into the standardized data (B/S) 303 or the standardized data (P/L) 304. One of the common codes in the common code database 206 is assigned to each element in the standardized data definition database 205.

The standardized data (B/S) database 207 is a database that stores standardized data concerning balance sheets (B/S) of the standardized data.

The standardized data (P/L) database 208 is a database that stores standardized data concerning profit-and-loss statement (P/L) of the standardized data.

The basic figure database 209 is a database that stores data on the basic figures generated by the basic figure generation unit 204.

Returning to the explanation of FIG. 1, the business systems 120 in the bank are systems used for operations in the bank. The business systems 120 may include one or more business systems of any type, including accounting systems for bank operations, such as deposit, lending, and exchange operations.

The business systems 130 in the group companies are systems used for operations in the group companies. The group companies include group companies of the bank having the business systems 120 in the bank. The group companies may include not only companies that operate financial business but also companies that operate business other than financial business. The business systems 120 may include one or more business systems in a securities company and the like.

The terminals 140 for bank clerks are terminals such as personal computers for bank clerks to use the management information system 110. The bank clerks are bank clerks of the bank having the business systems 120 in the bank. The number of terminals 140 for bank clerks can be any number.

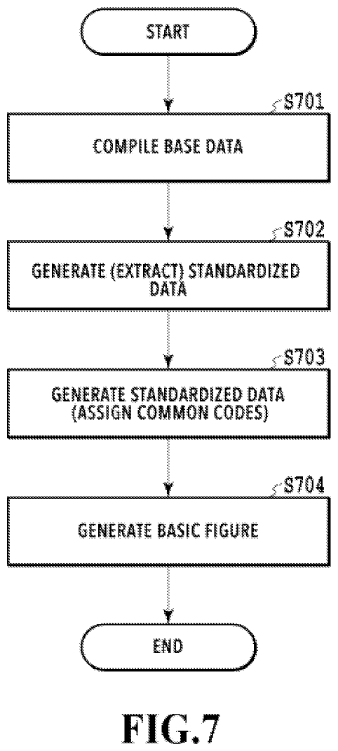

FIG. 7 is a sequence diagram illustrating a process procedure of the management information system 110 according to the embodiment of the present invention.

At step 701, the management information system 110 receives the base data 302 from the business systems 120 in the bank and the business systems 130 in the group companies.

At step 702, the management information system 110 extracts data of some items out of the data of the multiple items in the base data 302 received at step 701, based on the standardized data definition database 205.

At step 703, the management information system 110 assigns common codes to the data extracted at step 702, based on the standardized data definition database 205. With steps 702 and 703, the standardized data 303 and 304 is generated from the base data 302.

At step 704, the management information system 110 combines multiple pieces of standardized data 303 and 304 generated at steps 702 and 703, to generate the basic figures 305. The process procedure is performed as described above.

As described above, with the invention of the present application, data on an element basis that is easy to handle in management accounting and financial accounting (in other words, standardized data 303 and 304) can be extracted out of the data (in other words, base data 302) including multiple items that are conventionally managed in a collective manner such as on a lending-case basis (in other words, on a record basis), and common codes can be assigned to the extracted data. Since data is componentized piece by piece as described above, the data can be handled more easily than in a conventional way.

Although embodiments of the present invention have been described until now, the above embodiments are mere examples, and the present invention is not limited to the above embodiments. It goes without saying that the present invention may be implemented as various different embodiments within the scope of the technical idea.

The scope of the present invention is not limited to the exemplary embodiments that have been described and illustrated in the figures but includes all embodiments that provide effects equivalent to the object of the present invention. Further, the scope of the present invention is not limited to the combinations of features of the invention defined by each claim but can be defined by any desired combination of specific features of all the disclosed features.

### REFERENCE SIGNS LIST

110 management information system
120 business system in a bank
130 business system in group companies
140 terminal for bank clerks
201 database compilation unit
202 extraction unit
203 common code assigning unit
204 basic figure generation unit
205 standardized data definition database
206 common code database
207 standardized data (B/S) database
208 standardized data (P/L) database
209 basic figure database
301 raw data
302 base data
303 standardized data (B/S)
304 standardized data (P/L)
305 basic figure
306 purpose-based database
401 element 1
402 element 2
403 element 3

1. A management information system connected to multiple business systems inside and outside a company, located in a home country and a foreign country, the management information system being a system to support management of a financial institution or a financial holding company group including the financial institution, wherein the management information system comprises:
a database compilation unit configured to receive base data managed by the business systems based on respective standards, from the business systems, the base data including data of multiple items and being managed on a record basis;
an extraction unit configured to extract data of one or more items out of the received base data;
a common code assigning unit configured to generate standardized data manageable based on a unified standard by assigning a common code to the extracted data of the one or more items; and
a basic figure generation unit configured to generate a basic figure by combining multiple pieces of the standardized data based on the common code, the basic figure being used for the management of the financial institution or the financial holding company group including the financial institution.

2. The management information system according to claim 1, wherein the base data includes financial data and data on risk involved in an operation of the financial institution.

3. The management information system according to claim 2, wherein the basic figure is generated by performing calculation using figures in the standardized data on a customer basis or on a department basis for each code of each classification of the common code.

4. The management information system according to claim 3, wherein the management information system is capable of generating accounting information calculated based on the basic figure from risk information and financial information whose outer forms are unified.

5. A method executed by a management information system connected to multiple business systems inside and outside a company, located in a home country and a foreign country, the management information system being a system to support management of a financial institution or a financial holding company group including the financial institution, the method comprising:
receiving base data managed by the business systems based on respective standards, from the business systems, the base data including data of multiple items and being managed on a record basis;
extracting data of one or more items out of the received base data;
generating standardized data manageable based on a unified standard by assigning a common code to the extracted data of the one or more items; and
generating a basic figure by combining multiple pieces of the standardized data based on the common code, the basic figure being used for the management of the financial institution or the financial holding company group including the financial institution.

6. A non-transitory computer-readable storage medium having computer-executable instructions which causes, when executed by a processor, a management information system connected to multiple business systems inside and outside a company, located in a home country and a foreign country, the management information system being a system to support management of a financial institution or a financial holding company group including the financial institution, to perform a method comprising:
receiving base data managed by the business systems based on respective standards, from the business systems, the base data including data of multiple items and being managed on a record basis;
extracting data of one or more items out of the received base data;
generating standardized data manageable based on a unified standard by assigning a common code to the extracted data of the one or more items; and
generating a basic figure by combining multiple pieces of the standardized data based on the common code, the basic figure being used for the management of the financial institution or the financial holding company group including the financial institution.

7. The management information system according to claim 2, wherein the management information system is capable of generating accounting information calculated based on the basic figure from risk information and financial information whose outer forms are unified.

8. The management information system according to claim 1, wherein the basic figure is generated by performing calculation using figures in the standardized data on a customer basis or on a department basis for each code of each classification of the common code.

9. The management information system according to claim 8, wherein the management information system is capable of generating accounting information calculated based on the basic figure from risk information and financial information whose outer forms are unified.

10. The management information system according to claim 1, wherein the management information system is capable of generating accounting information calculated based on the basic figure from risk information and financial information whose outer forms are unified.
